(19) United States
(12) Patent Application Publication
(10) Pub. No.: US 2021/0211811 A1
(43) Pub. Date: Jul. 8, 2021

(54) MULTI-PART EARDRUM-CONTACT HEARING AID PLACED DEEP IN THE EAR CANAL

(71) Applicant: Vibrosonic GmbH, Mannheim (DE)

(72) Inventors: Tobias Fritzsche, Ludwigshafen (DE); Dominik Kaltenbacher, Mannheim (DE); Jonathan Schachtele, Mannheim (DE); Florian Strobl, Heddesheim (DE); Martin Theuring, Mannheim (DE)

(21) Appl. No.: 17/250,069

(22) PCT Filed: May 20, 2019
(86) PCT No.: PCT/EP2019/062979

§ 371 Date: Nov. 18, 2020

(30) Foreign Application Priority Data
May 18, 2018 (DE) 10 2018 207 922.6

(51) Int. Cl. H04R 25/02; H04R 25/00

(52) U.S. Cl. CPC H04R 25/02; H04R 25/556; H04R 2225/31; H04R 25/602; H04R 25/554

(57) ABSTRACT

The invention relates to a hearing aid comprising a an eardrum module and an ear canal module, the eardrum module being able to be arranged to be in contact with the eardrum of a person and the ear canal module being able to be arranged in the ear canal of the person.

The invention relates to a hearing aid comprising a an eardrum module and an ear canal module, the eardrum module being able to be arranged to be in contact with the eardrum of a person and the ear canal module being able to be arranged in the ear canal of the person.

Eardrum-contact hearing aids create a sound impression on the wearer by exerting a force on the eardrum through direct mechanical contact. This force, which is applied at least partially to the eardrum, causes a deformation that is transmitted to the ossicular chain and thus penetrates into the inner ear. A higher efficiency and a flatter frequency response can be achieved compared to a classic hearing aid, in which the transmission to the eardrum is via airborne sound. In an eardrum hearing aid, a motor element (actuator) engages the eardrum via a mechanical connection. This is realized by a structure that contains the actuator and directly contacts the eardrum. This structure should be light so that its inertia does not cause an unpleasant feeling of pressure or even pain when the head is moved.

Users of hearing aids also place great importance on the fact that the hearing aid is not noticed by other people. Therefore, it should preferably be placed in the ear canal, invisible from the outside. It should contain an energy storage for supply, which can be exchanged and/or charged. The structure of the hearing instrument that is in contact with the eardrum is referred to as the eardrum module (TFM). Since the eardrum is very sensitive and lies deep in the narrow ear canal, for safety reasons it should only be inserted or removed by a specialist and otherwise remain on the eardrum.

The object of the present invention is to specify a hearing aid which can be brought into contact with the eardrum, although the components in contact with the eardrum may be designed to be light and the eardrum module can still be reliably supplied with signals and energy.

This object is solved by the hearing aid according to claim 1. The dependent claims indicate advantageous further refinements of the hearing aid according to the invention.

According to the invention, a hearing aid is specified which has an eardrum module which can be placed in contact with a person's eardrum and an ear canal module which can be placed in the person's ear canal. The fact that the eardrum module can be placed in contact with a person's eardrum implies that the eardrum module is suitably designed, and in particular that it has suitable dimensions. The dimensions can be individually adapted to a specific person. If the eardrum module is to be manufactured in series, the dimensions of the eardrum module can be adapted to the average dimensions of adult persons. If the eardrum module is intended for children, its dimensions may be adapted to the average dimensions of children in the appropriate age group. The same applies to the ear canal module, the dimensions of which can also be individually dimensioned for the ear canal of a particular person or adapted to average dimensions.

According to the invention, the eardrum module and the ear canal module, in the intended state in which the eardrum module and the ear canal module are located in the ear of the person, are connected to each other only by means of at least one cable. Thus, apart from the restriction of movement by the person's ear, the eardrum module and the ear canal module can move freely relative to each other within the maximum distance given by the length of the cable. This mobility is preferably limited at most by the stiffness of at least one cable. According to the invention, the eardrum module and the ear canal module are electrically connected to each other via at least one cable.

Because the eardrum module is separated from the ear canal module and connected to it only by a cable, the eardrum module exerts a force on the eardrum only due to its inertia. However, since many components of the hearing aid can be placed in the ear canal module, the mass of the eardrum module can be kept small, so that the inertial force exerted on the eardrum is also small.

The ear canal module can preferably be placed deep in the ear canal. For example, a proximal end of the ear canal module may be located close to the eardrum, for example about 1 to 6 mm from the eardrum, in the external ear canal when the hearing instrument is in the intended state. A distal end of the ear canal module may advantageously be located proximal to a distal end of the ear canal. The ear canal module and the eardrum module may be advantageously designed to continuously remain in the ear canal for a longer period of time, for example more than one day, preferably more than one week, on an experimental basis more than one month. They are, advantageously, not removed by the patient.

In an advantageous configuration of the invention, the cable may be elastic and/or plastically stretchable. This makes it possible to insert the eardrum module and the ear canal module into the ear one after the other. The eardrum module can be inserted first while the ear canal module is still outside the ear canal. Once the eardrum module is positioned at the eardrum, the ear canal module can be pushed until it is at the target position in the external ear canal.

For this purpose, in a favourable configuration of the invention, the cable may be elastically stretchable from a wound or folded state and/or the cable itself may be made of an elastic material. The cable may, for example, also be designed like a spring, spirally or helically wound. It is advantageous that the geometry and stiffness of the cable are adjusted in such a way that any stretching of the cable required for insertion (e.g. approx. 3 cm) is low enough to avoid unpleasant or harmful effects on the eardrum. Advantageously, the cable is designed in such a way that, when relaxed, it assumes a geometry that fits between the eardrum module and the ear canal module in their intended arrangement. For example, the cable can be advantageously wound into a spiral or helical shape.

In an advantageous design of the invention, the cable may be in the form of a flexible laminate comprising at least one electrically insulating layer and at least one electrically conductive layer disposed on the electrically insulating layer. Advantageously, the cable can be designed as a flexible printed circuit board.

In an advantageous design, the cable may be connected or connectable to the ear canal module via a plug or an abutting connection. The eardrum module can then be placed against the eardrum with the cable attached to it, while the end of the cable facing away from the eardrum module is held outside the ear. The ear canal module may already be fixed at this outer end, or it may be connected to the ear canal module, for example via a plug or an abutting connection. Before inserting the ear canal module into the ear, the cable is then connected to the ear canal module and the ear canal module is inserted into the ear canal. Optionally, the cable can be attached to the eardrum module in a non-detachable way. Non-detachable means that the cable cannot be disconnected from the eardrum module in a reconnectable manner.

Advantageously, the eardrum module has at least one actuator. The eardrum module is advantageously designed so that an oscillation of the actuator can be transmitted to the eardrum when the eardrum module is in contact with the eardrum. In particular, oscillations of the actuator can therefore be transferred to the eardrum when the eardrum module is arranged as intended.

In an advantageous design, the actuator may have a membrane structure comprising at least one carrier layer and at least one piezo layer disposed on the carrier layer, the piezo layer comprising at least one piezoelectric material. By applying a voltage to the piezo layer, oscillations of the membrane structure can then be generated.

Advantageously, the membrane structure may have, in an area of the membrane structure, at least one intersecting line intersecting all layers of the membrane structure, by which the membrane structure is divided into at least one, two or more segments. The intersecting line advantageously intersects all layers of the membrane structure, so that the membrane structure is mechanically decoupled at the cutting line. The membrane structure may advantageously be circular. The intersecting lines can then run radially to the centre of the membrane structure. A subdivision with only one intersecting line is also possible, for example if the intersecting line runs spirally from the centre of the membrane structure to an outer edge of the membrane structure. By dividing the membrane structure in this way, it can be deflected with particularly large amplitudes, thus allowing good coupling to the eardrum.

Advantageously, the ear canal module can have a storage for electrical energy. This can be a non-rechargeable battery or, advantageously, an accumulator.

In an advantageous configuration of the invention, the ear canal module may have at least one microphone. In this way, the ear canal module can pick up sound in the ear canal and convert it into an electrical signal. This electrical signal can then be used to control the eardrum module. Placing the microphone in the ear canal module allows for a particularly natural sound impression. Because the ear canal module and the eardrum module are separated from each other, the eardrum module is not loaded with additional mass.

It is advantageous if the ear canal module, at least if it is to be placed in the ear canal, has anchoring means on its outer side with which it can be held to the inner wall of the ear canal. Such anchoring means can be, for example, bristles, shields, sails, rings, spirals or other shaped structures on the outside of the ear canal module, which extend from the surface of the electrical device to the ear canal wall, where they support the ear canal module. Preferably, the anchoring means have a certain mechanical flexibility, so that the anchoring means adapt to the shape of the ear canal when inserted in its intended position. This can be achieved, for example, by moulding the anchoring means from an elastic material such as silicone, polyurethane foam or a similar material. If the ear canal module is in contact with a cable by means of a mechanical contact, for example a plug, a force with which the anchoring means hold the ear canal module in the ear canal is preferably greater than a force required to make and/or break the mechanical connection. In this manner, mechanical contact can be made and/or broken without moving the ear canal module.

In an advantageous design, electrical energy can be supplied wirelessly to the ear canal module. To this end, the ear canal module may have an interface for the transmission of electrical energy. Advantageously, this should be conveniently usable by the patient. For a wireless transmission, for example, inductive energy transmission, capacitive energy transmission and/or energy transmission by means of electromagnetic waves such as radio or light, or even energy transmission by means of ultrasound are possible. In this way it is possible to avoid electrical contacts on the ear canal module that are susceptible to dirt and wear and also to avoid touching the ear canal module. Because the battery can be rechargeable, the ear canal module can use more power without the need for frequent visits to a professional or frequent battery replacement.

However, it is also possible to supply the energy to the ear canal module via a reconnectable detachable cable connection. Such a reconnectable detachable connection can be, for example, a plug connection or an adjacent contact connection.

In an advantageous configuration of the invention, an external module may be provided for the hearing aid which is connectable to the ear canal module, e.g. for supplying the ear canal module with electrical energy. Such an external module can be, for example, a charging module. For example, the external module may have a battery that is, particularly preferably, rechargeable. However, replaceable, non-rechargeable batteries are also possible.

Advantageously, the external module can be connected to the ear canal module via a wireless connection or a re-connectable detachable connection for supplying the ear canal module with electrical energy.

Preferably, the external module can be designed so that it can be placed on the ear outside the ear canal. For example, the external module may have one or two earpieces that are shaped so that they can be held by or on one ear of the person. For example, the external module can be a headphone design, i.e. it can be worn on the head and have earpieces that are intended to be placed in, on or above the auricle.

Since there is more space available for the external module, the batteries or accumulators can be designed in such a way that they are sufficient for several charging processes of the ear canal module. One capacity of the batteries can therefore be several times the capacity of an energy storage device in the ear canal module.

It is also possible to provide both wireless and wired connections for energy transfer between the external module and the ear canal module, so that the patient can decide which connection to use for transmission depending on the availability of charging adapters and other parameters such as charging time and freedom of movement. If the external module has a cable connection for charging a battery of the external module, it is advantageous if this can also be used while the external module is charging the ear canal module. In this way, the ear canal module and the external module can be charged simultaneously, with the energy for both processes being supplied simultaneously from the cable connection.

In an advantageous design, the external module may have a bracket on which the at least one earpiece is placed and which is dimensioned so that it can reach over the person's head. It is also advantageous if the earpiece(s) can be placed at least partially in one ear canal of the person. However, it is advantageous if the earpieces are accessible from the outside and can be placed in the ear canal and removed from the ear canal by the user without professional help.

To establish a wireless connection between the external module and the ear canal module, optical, acoustic (ultrasound), inductive, capacitive and/or electromagnetic wave-based connections such as light and/or radio can advantageously be used.

In an advantageous design, the ear canal module and/or eardrum module may contain active electronic components such as active amplifiers, filters and/or signal processors. In this case it is advantageous to transmit auxiliary power to the corresponding module to operate the active electronics. Such auxiliary energy can be transmitted from the external module to the ear canal module and/or from the ear canal module to the eardrum module. The auxiliary power can be used to operate active electronic components of the ear canal module and/or the eardrum module. In particular, such auxiliary energy can be used to charge a rechargeable storage device for electrical energy, such as an ear canal module accumulator.

It is also advantageous to transmit an information signal, preferably an audio signal, from the external module to the ear canal module and/or from the ear canal module to the eardrum module.

In an advantageous configuration of the invention, energy and information signals can be transmitted from the external module to the ear canal module and/or from the ear canal module to the eardrum module via the same channel, for example from the ear canal module to the eardrum module via the cable to which they are connected.

However, it is also possible to transmit the signal and the energy via separate channels, which can also be implemented using different of the above-mentioned options. In this way, it is possible to optimize the transmission paths for the information signal and energy independently of each other for information transmission and energy transmission. Inductive coupled resonant circuits, which work in or near resonance of the resonant circuits, are, for example, advantageous for an efficient energy transfer. The higher the quality factor of the resonant circuits, the more efficiently the energy can be transmitted. For signal transmission, however, a rather low quality is advantageous in order to achieve sufficient bandwidth. The quality requirements can therefore be opposing for signal transmission and for energy transmission. If signal transmission and energy transmission are implemented independently of each other, they can be optimized independently of each other. It may be advantageous, for example, to have two individually optimized inductive transmissions or also, for example, an inductive transmission of the energy and an optical transmission of the signal, which is advantageous because optical transmitters and receivers can be realized in a very small installation space while at the same time an inductive resonant energy transmission is very efficient.

The information signal can be transmitted in analogue or digital form, for example.

In an advantageous design, the external module may have controls and/or an interface to receive data and/or audio signals from a data or audio source. Such an interface can, for example, be a Bluetooth interface. Operating commands can, for example, also be entered using one or more buttons on the external module.

In an advantageous configuration of the invention, the external module and/or the ear canal module may have one or more proximity radio interfaces such as Bluetooth or inductive interfaces such as NFMI. This makes it possible to use the hearing aid, for example, as a hands-free device for a mobile phone or as a headset when listening to music or watching a film. In environments with a high degree of ambient noise, the signals of external microphones placed close to the sound source of interest, for example a conversation partner, can be integrated. Such microphones can be coupled to the external module or the ear canal module in an appropriate manner.

A design in which the external module has the appropriate interface is advantageous here, as this places less strain on the smaller battery of the ear canal module. In addition, the electromagnetic waves in the external module are less damped or absorbed by body tissue. It is therefore advantageous to use the external module as a communication relay for connecting external devices. This means that the external module can establish the communication link to external devices, such as a mobile phone or smartphone or other such devices, while maintaining the advantageous wireless connection to the ear canal module. The communication between the external module and the ear canal module is then only over a short distance, which saves energy. Preferably, the external module should be arranged in such a way that it has a line of sight to the ear canal module.

Configuration data can also be transferred to the ear canal module with the external module. For example, the configuration data can be transmitted from an external device to the external module, which then transmits it to the ear canal module. A data and power transmission to the ear canal module can be simultaneously provided by the external module. In this way, the higher power requirement of the ear canal module during signal transmission from and/or to the external module can be compensated by the energy transfer, so that the battery of the ear canal module is not stressed. It may even be possible to charge the hearing aid battery or accumulator at the same time as the signal is transmitted. The external module can be worn like a headphone for charging and/or coupling, for example.

The ear canal module and the eardrum module can be considered together as a hearing aid in some designs, although they can also act as hearing aids independently of the external module.

It is also possible to design the system in such a way that the ear canal module merely passively establishes an electrical connection between the eardrum module and the external module. It then provides a plug connection to the external module, for example, which is continued via the cable to the eardrum module. A signal processor, energy storage, microphone and possibly other components are then located in the external module.

While the user is wearing the external module, some versions of the external module may have their ear canal blocked, shielding the microphone of the ear canal module from the environment. In order to be able to hear normally while using the external module, one or more microphones may be integrated into the external module. The audio signals picked up by the microphones can then be transferred to the ear canal module via the interface for data or signal transmission between the external module and the ear canal module. The ear canal module can then transmit these to the eardrum module in addition to or instead of the signals picked up by the microphone of the ear canal module.

As explained above, different, preferably wireless, transmission techniques can be used for data and power transmission between the external module and the ear canal module. For example, inductive power transmission and data transmission by radio, for example via Bluetooth or proprietary interfaces in an ISM band, is advantageous. External devices can preferably be connected to the external module using standardized, manufacturer-independent wireless interfaces in order to be compatible with as many devices as possible. The industry standard Bluetooth, for example, is suitable here.

The external module can have different designs. For example, for the left and right ear completely decoupled parts are possible, for example similar to the “Truly Wireless Earbuds” or “Hearables”. Another possibility is a design in clip headphone form, in which the ear parts of the external module rest on or completely enclose the auricle. In another version, the external module may have two elements placed and fixed in or on the auricle, connected by a flexible structure such as a rubber band or cable.

The external module may have a transmitter unit for inductive energy transmission for charging the ear canal module and optionally communication devices for external devices, electronic modules for control, storage and signal processor, one or more energy stores, operating elements, indicating elements and/or microphones. If a left and a right earpiece of the external module are decoupled from each other, a wireless communication interface can be provided between the two earpieces. In this manner, synchronous states on both sides can be guaranteed. Such a wireless communication interface can be established, for example, by means of an inductive link, e.g. NFMI, as this is less attenuated by the intermediate head than a transmission by radio.

Since not every user needs a bilateral hearing aid, it is advantageous if the external module also works with only one hearing aid.

The hearing aid according to the invention including the eardrum module and the ear canal module (two-part version), or containing the eardrum module, the ear canal module and the external module (three-part version) can advantageously have an interface to receive operating commands such as on/off, volume up/down, selection of a configuration profile. In order to keep the ear canal module and/or the external module small, it may be advantageous to provide solutions other than buttons. In an advantageous design, the commands can be transmitted to the ear canal module and/or the external module by means of an optical interface. In this case, it is advantageous if the ear canal module or the external module has a photodiode that can be designed to be very space-saving. An external device such as a smartphone, wristwatch, key ring, amulet, etc., can send data to this interface by simply flashing a light emitting diode or the display. Information can also be transmitted in the opposite direction, for example by means of a light-emitting diode on the ear canal module or on the external module. A blinking of this LED can be received, for example, by the camera of a smartphone or another photoreceiver.

Desired settings can then first be made with the external device and then transferred to the hearing aid, i.e. the external module and/or the ear canal module, by holding the external device with the optical transmitter/receiver towards the corresponding module. When communication with the ear canal module is established, the external device is preferably held so that a line of sight to the ear canal module is established.

If a data transmission from the ear canal module or the external module to the external device is implemented, states of the ear canal module or the external module, such as a charge level, can be displayed. Radio transmission (Bluetooth LE, etc.) is also possible with an external device, although it should be held at ear level to transmit the settings. Even larger configuration data packages can be transferred in this way.

In the following, advantageous optional possibilities for implementing the hearing aid according to the invention are summarized.

The hearing aid according to the invention can have an eardrum module membrane and an ear canal module that can be placed deep in the ear canal.

The ear canal module can be designed to remain in the ear canal for a longer period of time, for example, more than one day, without interruption.

According to the invention, the ear canal module and the eardrum module are connected to each other by a cable. The cable can be a spiral cable and in particular be based on a flex PCB technology. The spiral cable can also consist of two spirals connected in series in order to achieve a lower overall spring constant and thus a lower restoring force with the same deflection and to increase the overall extensibility. When a coil spring is stretched, a torsional moment may be generated. This can lead to material stress or unintentional twisting of the two ends. If interconnected individual spirals are used, they are therefore advantageously connected in such a way that the torsional moments of the individual spirals at the interface of the two spirals are directed in the same direction when the ends are fixed. In this case, twisting of the interface is not hindered and stresses in the material or at the ends are avoided.

The cable can be connected on at least one side via a detachable plug connection.

A wireless power and/or signal interface may also be provided between the eardrum module and the ear canal module. The signal transmission can be optical (visible light, infrared light, ultraviolet light), inductive (mainly via a magnetic field), capacitive (mainly via an electric field), via electromagnetic waves (e.g. radio), and/or via ultrasound (with a carrier frequency outside the audible spectrum).

Power can also be transmitted between the ear canal module and the eardrum module optically (by means of visible light, infrared light, ultraviolet light), inductively (mainly via a magnetic field), capacitively (mainly via an electric field), via electromagnetic waves (radio), and/or via ultrasound (outside the audible spectrum).

Different principles for power and signal transmission can be advantageously provided.

It is also possible to provide the same principle for the transmission of power and signals. In particular, the same transmitting and/or receiving structure or parts of it may be used for signal and power transmission. For example, the same coil or the same coil with several taps can be used.

In particular, different frequency ranges can be used for power and signal transmission. The signal transmission can advantageously use the power transmission as a carrier signal (e.g. modulated by the signal, in-band communication).

The ear canal module may advantageously have a battery or accumulator. The battery or accumulator can be advantageously rechargeable. Charging in the ear canal is particularly advantageous (without removing the ear canal module).

It may be advantageous to have an external module or charging module, although the terms external module and charging module can also be used synonymously. The external module can optionally be worn on the head. The external module can optionally have its own battery, which can be advantageously rechargeable.

The external module can optionally establish a wireless connection to peripheral devices (e.g. smartphones etc.), advantageously using a standardized interface such as Bluetooth.

The external module may have one or more microphones, which can advantageously be used during charging to maintain the hearing aid function.

Charging can advantageously be carried out by wireless energy transmission, for example optically (by visible light, infrared light, ultraviolet light), inductively (mainly by a magnetic field), capacitively (mainly by an electric field), by electromagnetic waves (radio), and/or by ultrasound (outside the audible spectrum).

The external module can advantageously establish a wireless data connection to the ear canal module. This data or signal transmission take place via optical (visible light, infrared light, ultraviolet light), inductive (mainly via a magnetic field), capacitive (mainly via an electric field), via electromagnetic waves (radio), and/or ultrasound (with a carrier frequency outside the audible spectrum) means. There may be different principles for the transmission of power and signals.

It is also advantageous to provide the same principle for the transmission of power and signals. In this case, the same transmitting and/or receiving structure or parts of it can be used for signal and power transmission. For example, different frequency ranges can be used for power and signal transmission. It is also possible that the signal transmission uses the power transmission signal as a carrier signal, which is modulated for signal transmission.

Charging can also be achieved via a wired interface. For example, the external module and the ear canal module can be connected via a plug connector. It is advantageous to use a plug connection that can be connected without being seen. Power and/or data can be transmitted via such a wired interface.

The ear canal module can advantageously have an interface for the transmission of configuration data with low bandwidth. Such data can be, for example, a volume setting, a configuration profile, an equalizer configuration, the presence of the external module and the like. The interface can advantageously be optical, wherein the ear canal module in particular can have an optical receiver such as a photodiode. The transmission can take place, for example, by flashing a display or LED on an external device such as a smartphone, the external module or a wristband.

In an advantageous configuration of the invention, the ear canal module may be designed without a battery. In this case, the external module can be considered part of the hearing aid, which is worn in the ear canal in addition to the ear canal module and contains a battery. The external module can then be provided to be removed by the user. A battery of the external module may be non-rechargeable and replaceable from the carrier or it may be rechargeable. For example, it can be removed by the user and inserted into a charger. The battery may also be designed to be non-removable and chargeable via a contact or contactless connection. Such a connection can be made as described above while the external module is worn in the ear by the user.

The transmission between the external module and the ear canal module can be wired. For example, the external module and the ear canal module can be connected via a plug connection, advantageously via a plug connection that can be connected without being seen. The microphone, signal processor and/or amplifier can be distributed between the ear canal module and the external module as required. Advantageously, all active components are arranged in the external module and the ear canal module and/or the eardrum module contain only passive components.

The ear canal module and the external module can be connected to each other via a wireless interface. The ear canal module may have active amplifier electronics. Signals may be transmitted between the ear canal module and the external module by optical (visible light, infrared light, ultraviolet light), inductive (mainly via a magnetic field), capacitive (mainly via an electric field), by means of electromagnetic waves (radio) and/or ultrasound (with a carrier frequency outside the audible spectrum) means.

Power may be transmitted between the external module and the ear canal module by optical (visible light, infrared light, ultraviolet light), inductive (mainly via a magnetic field), capacitive (mainly via an electric field), via electromagnetic waves (radio) and/or ultrasound (with a carrier frequency outside the audible spectrum) means. Different principles can be used for the transmission of power and signals or the same principle can be used for the transmission of power and signal. In the latter case, for example, the same transmitting and/or receiving structure or parts of it (for example, the same coil or a coil with multiple taps) can be used for signal and power transmission. It is also possible to use different frequency ranges for power and signal transmission. Signal transmission can also use power transmission as a carrier signal (modulated by the signal, in-band communication).

The signal can advantageously be transmitted in analogue or digital form. In the latter case, the ear canal module may have a digital-to-analog converter.

In an advantageous design, the ear canal module can be implemented without active amplifier electronics. It is possible for the signal for the transducer to be transmitted directly with sufficient power. The transmission can take place in the baseband or the signal can be passively demodulated. The signal transmission take place via optical (visible light, infrared light, ultraviolet light), inductive (mainly via a magnetic field), capacitive (mainly via an electric field), via electromagnetic waves (radio), and/or ultrasound (with a carrier frequency outside the audible spectrum) means.

The external module may have an interface for transmission of configuration data with low bandwidth. Such data can be, for example, a volume setting, a configuration profile, an equalizer configuration, a presence of the external module and the like. The interface can be optical, for example, in which case the external module can have an optical receiver such as a photodiode. The transmission can then take place via flashing of a display or LED on an external device such as a smartphone, wristwatch, keychain, or bracelet.

In an advantageous design, the ear canal module may have at least one through-hole extending from a side of the ear canal module facing the eardrum when positioned as intended to a side of the ear canal module facing outwards when positioned as intended. A cable can be run through these, one end of which can be disposed at the eardrum module.

The invention furthermore relates to a method of placing a hearing aid as described above in a person's ear, the ear canal module having a through-hole. In a first step, the eardrum module is placed in contact with the person's eardrum and the cable is held outside the ear with its end facing away from the eardrum module. The cable is then passed through the through-hole and the ear canal module is inserted into the person's ear canal on the cable.

The cable may advantageously have at least one contact point where the ear canal module is disposed when the ear canal module is in its intended position in the ear canal. It can then be in electrical contact with the ear canal module there, when arranged as intended.

It is advantageous for the cable to have a marking where the ear canal module is located on the cable when arranged as intended. The ear canal module can then be inserted into the person's ear canal on the cable up to the mark or up to a defined distance from the mark.

In the following, the invention will be exemplified by some figures. Identical reference signs indicate identical or corresponding characteristics. The characteristics shown in the examples can also be realized independently of concrete examples and combined between the examples.

In the drawings:

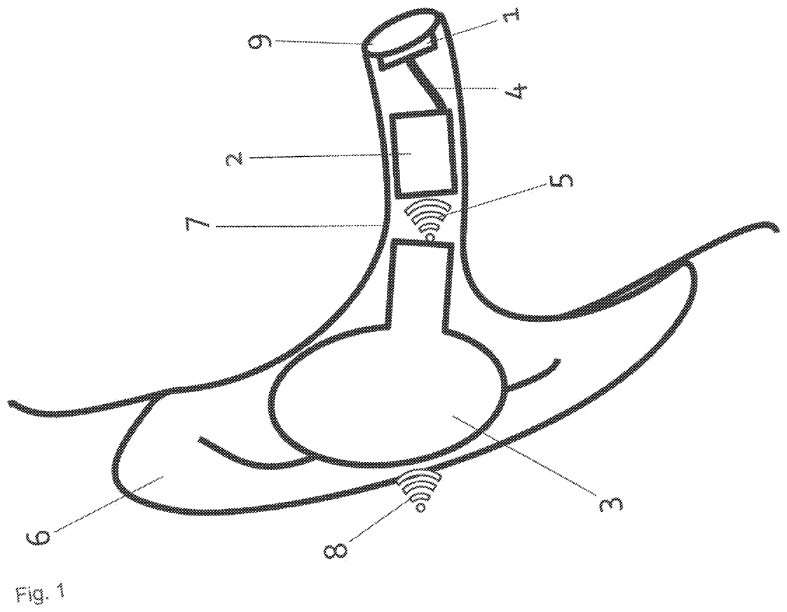

FIG. 1 shows a first exemplary design of a hearing aid according to the invention,

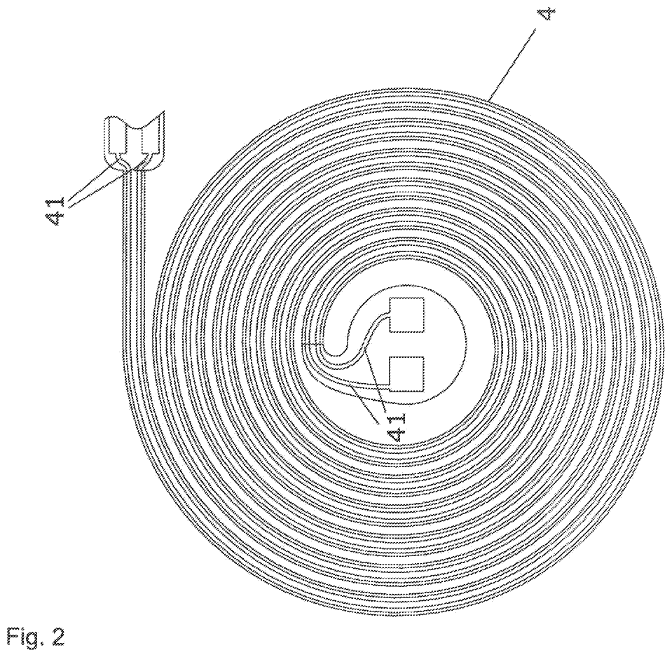

FIG. 2 shows a design of a spiral flexible cable to connect an eardrum module to an ear canal module,

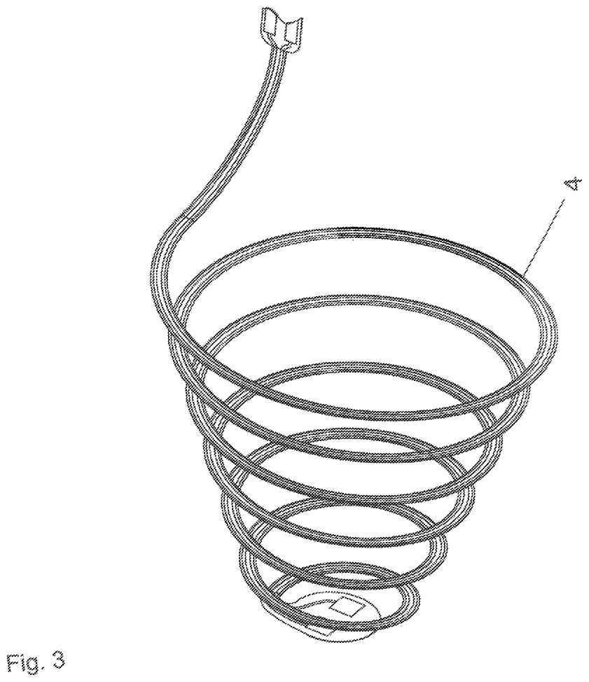

FIG. 3 shows a spiral-shaped, stretchable cable in the expanded state,

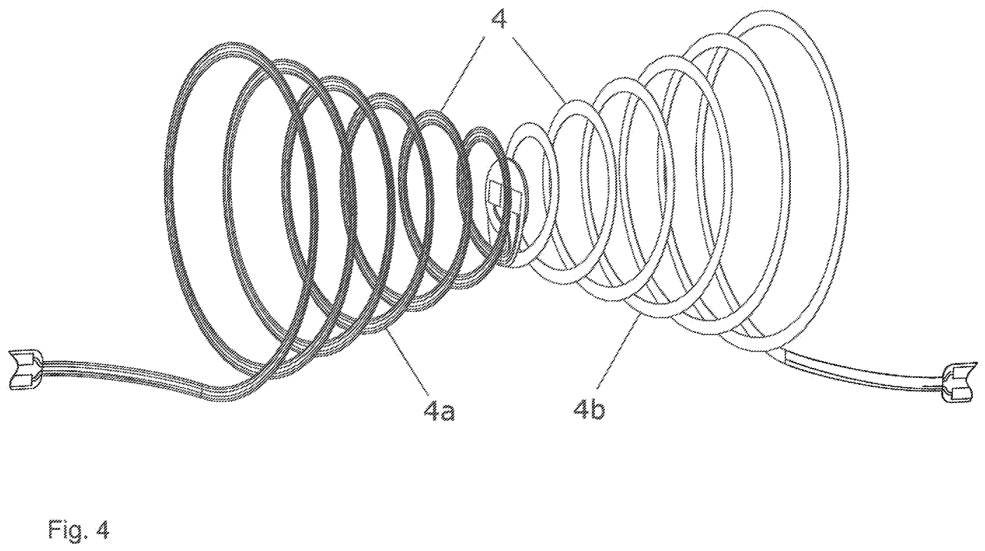

FIG. 4 shows an expandable cable with two connected spirals in expanded state,

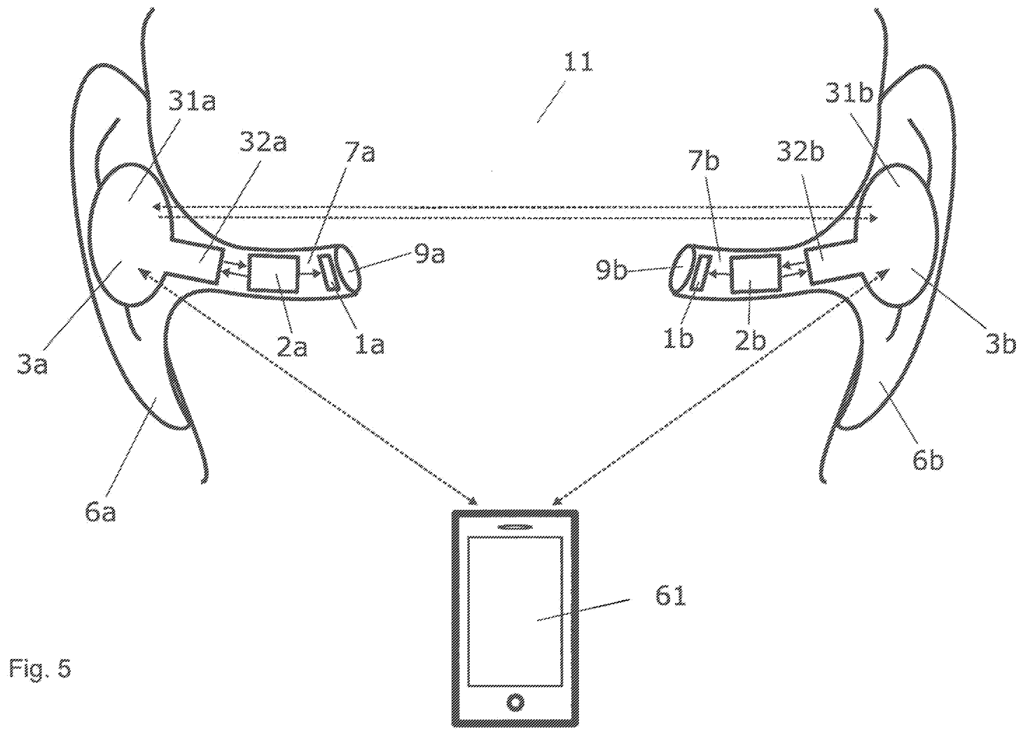

FIG. 5 shows a hearing aid according to the invention in two ears,

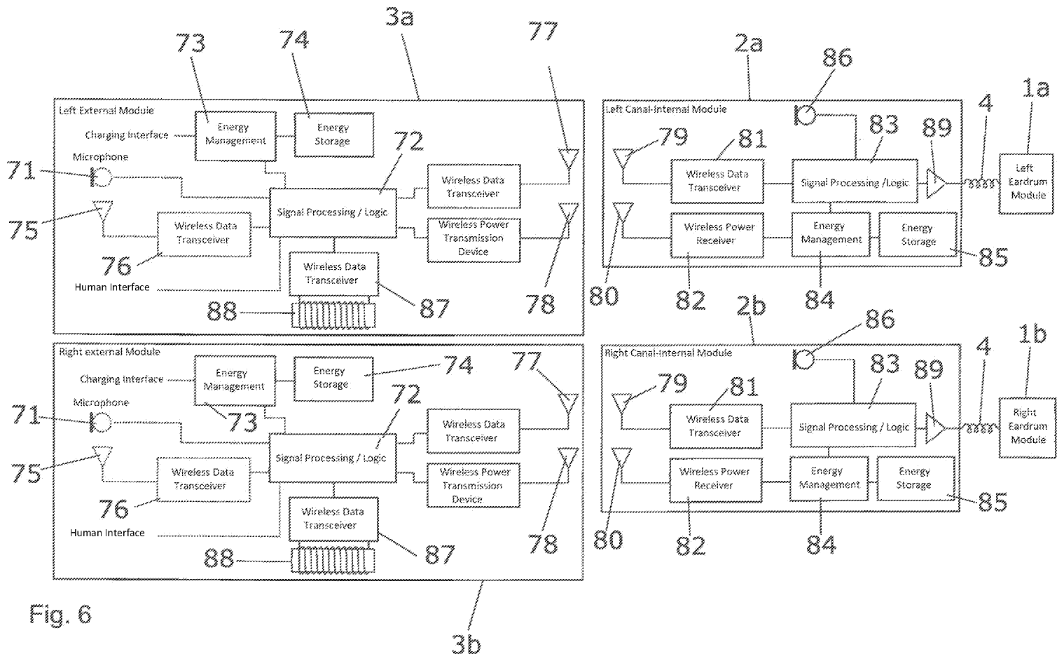

FIGS. 6 to 10 show exemplary block diagrams of hearing aids according to the invention,

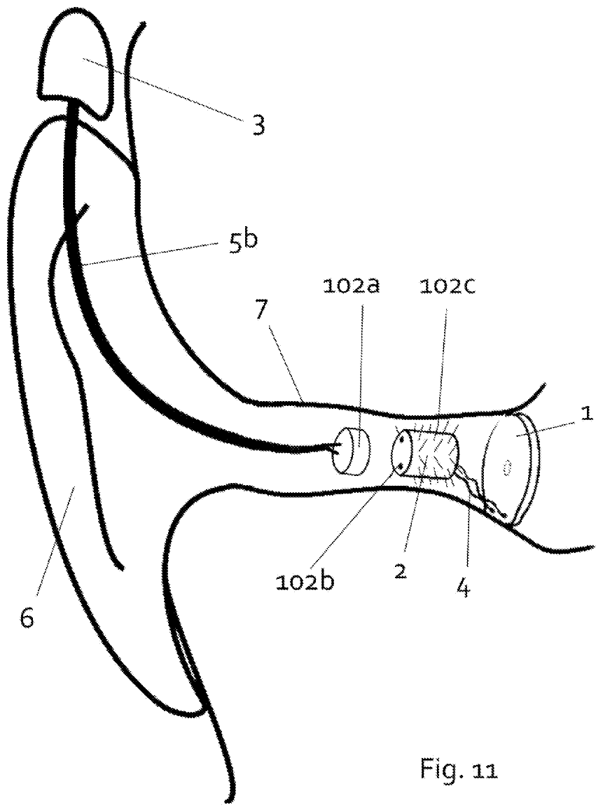

FIG. 11 shows a hearing aid with an energy transmission combining wired energy transmission with wireless energy transmission, and

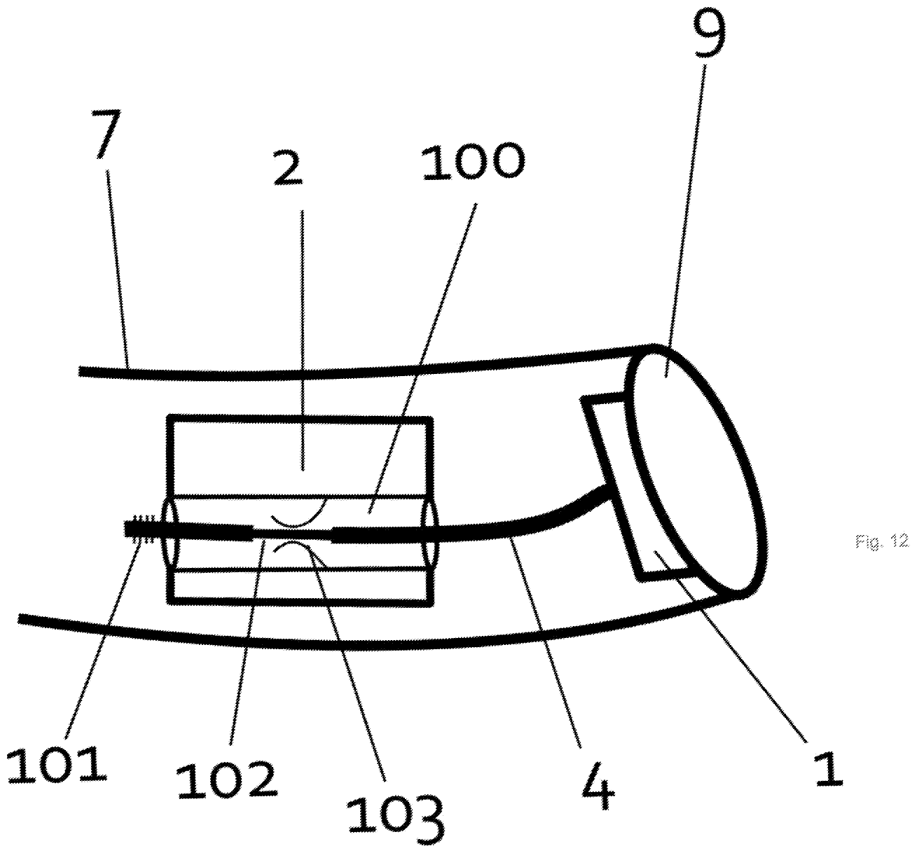

FIG. 12 shows a design of the invention in which a cable is passed through a through-hole in the ear canal module to connect an eardrum module to an ear canal module.

FIG. 1 shows a first exemplary embodiment of a hearing aid according to the invention. In the example shown in FIG. 1, the hearing aid has an eardrum module 1 that is disposed to be in contact with a person's eardrum 9. The hearing aid shown in FIG. 1 also has an ear canal module 2 which is located deep in the ear canal 7 of the person. The eardrum module 1 and the ear canal module 2 are located in the person's ear 6 and are connected to each other there only by a cable 4. The eardrum module 1 and the ear canal module 2 are electrically connected to each other via the cable 4.

In the example shown, eardrum module 1 has an actuator that is not shown and is designed in such a way that an oscillation of the actuator can be transmitted to the eardrum 9 when the eardrum module 1 is in contact with the eardrum 9. Such an actuator can, for example, be designed as a membrane structure comprising a carrier layer and a piezo layer, wherein the piezo layer contains a piezoelectric material so that by applying a voltage to the piezo layer, oscillations of the membrane structure can be generated which can be transmitted to the eardrum 9. The membrane structure may, for example, be divided into at least one, two or more segments in an area of the membrane structure by at least one intersecting line intersecting all layers of the membrane structure, so that the membrane structure is mechanically coupled at the intersecting line.

In the example shown, the ear canal module 2 has an electrical energy storage device (not shown) that may be rechargeable. Furthermore, in the example shown, the ear canal module 2 has at least one microphone, which is also not shown.

In the example shown in FIG. 1, the hearing aid also has an external module 3, which here functions as a charging module 3. The charging module 3 is coupled to the ear canal module 2 via a wireless interface 5, through which electrical energy and data signals such as audio signals can be transmitted from the charging module 3 to the ear canal module 2.

It can be seen that the ear canal module 2 is entirely disposed deep in the ear canal 7 of the person. In this condition, it can only be removed by a specialist. However, the external module 3 partially protrudes from the ear canal 7 and can be removed by the user. The external module 3 may itself have a battery that can be charged in the ear or by the user when removed.

The external module 3 also has an interface which can be used to transmit and receive radio signals 8. These radio signals can be used to receive data, such as configuration data and/or audio signals from an external device and/or send them to an external device.

FIG. 2 shows an example of a possible design of a cable 4 to connect eardrum module 1 and ear canal module 2. Cable 4 here is designed to be elastically stretchable, cable 4 being stretchable from a coiled, helical state. In the example shown in FIG. 2, cable 4 has a flexible laminate with an electrically insulating layer on one side and a structured electrically conductive layer 41 on the other. The cable 4 has a flat helical shape in a relaxed state and has a diameter of the helical shape of, for example, 5 mm. In this way, if ear canal module 2 and eardrum module 1 are positioned in ear canal 7 as intended, it can be rolled up and fit into the external ear canal 7.

FIG. 3 shows the design of cable 4 in an expanded state as shown in FIG. 2. It can be seen that the cable runs spirally in the expanded state and tapers towards the middle.

FIG. 4 shows a design of the elastically stretchable cable 4 with two halves 4a and 4b, halves 4a and 4b being joined together in the middle. FIG. 4 shows cable 4 in stretched condition. It can be seen that halves 4a and 4b widen away from the connecting point in the middle according to their respective spiral shape. In the non-expanded state, the two halves 4a and 4b can each have a helical shape, the two helical shapes being connected to each other in their centres.

FIG. 5 shows a 3-part design arranged in both ears 6a and 6b of a person 11. In each ear 6a and 6b of person 11, an eardrum module 1a and 1b is placed in contact with the respective eardrum 9a, 9b. In addition, an ear canal module 2a or 2b is arranged in each ear canal 7a or 7b of the person. Each ear 6a or 6b also contains an external module 3a or 3b. The external module modules 3a and 3b are designed so that they each have a section 31a and 31b, respectively, which has a diameter larger than the diameter of the ear canal 7a and 7b, respectively. The external modules 3a and 3b also have a section 32a and 32b, respectively, with diameters smaller than the diameters of the corresponding ear canals 7a and 7b, respectively.

The information in FIG. 1 applies accordingly with regard to the coupling of the external modules 3a and 3b with the ear canal modules 2a and 2b and the ear canal modules 2a and 2b with the eardrum modules 1a and 1b.

In the example shown in FIG. 5, the external modules 3a and 3b have interfaces that allow them to be coupled with an external device 61 such as a smartphone 61. In addition, the two external modules 3a and 3b have interfaces with which the two external modules 3a and 3b can be coupled together. This connection can be used, for example, to exchange data between the two external modules and thus enable binaural hearing aid functions.

FIG. 6 schematically shows an interconnection of two hearing aids, each having an external module 3a, 3b, an ear canal module 2a, 2b and an eardrum module 1a, 1b. In the following, the construction of only one of the hearing aids will be described. The above applies to the other hearing aid accordingly.

The external module 3a has a microphone 71 which is connected to a signal processor 72. The external module 3a also has an energy management unit 73 which is connected to an energy storage unit 74. The energy management unit 73 can also be connected to the signal processing unit 72 to exchange information. The energy management unit 73 can be supplied with electrical energy via an optional charging interface to charge the energy storage unit 74, provided that it is rechargeable. The energy management unit 73 supplies all active elements in the external module 3a with energy. For this purpose, corresponding connections are available, but they are not shown in this and the following figures.

The external module 3a can also have an antenna 75, which is connected to the signal processing unit 72 via a transceiver 76. It can be used to enter control commands, read out information and/or transmit audio signals. Optionally, a user interface can also be connected to the signal processing unit 72, which allows the user to adjust the volume, change programs, or switch the device off and on or into an energy-saving mode.

The external unit 3a also has a transmitter and receiver 77 for wireless data transmission, which allows data to be exchanged with a wireless transmitter and receiver 79 in the ear canal module 2a. The external module 3a also has a wireless transmitter 78 for wireless transmission of electrical energy to a receiver 80 of the ear canal module 2a. In the ear canal module 2a the receiver 79 is coupled to a signal processing unit 83 via a data transceiver 81. The wireless receiver 80 for electrical energy is connected to an energy management unit 84 via a transceiver 82 for energy transmission. The energy management unit 84 is coupled with an energy storage unit 85 and is also connected to the signal processing unit 83 for the exchange of information. The energy management unit 84 supplies all active elements in the ear canal module 2a with energy. For this purpose, corresponding connections are available, but they are not shown in this and the following figures. The ear canal module 2a also has a microphone 86, by means of which the sound to be heard can be picked up if the external module 3a is not disposed in the ear canal.

The ear canal module 2a has an amplifier 89 which amplifies the output signals of the signal processing unit 83 intended for eardrum module 1a. To transmit the signals, the ear canal module 2a is connected to the eardrum module 1a via a cable 4.

In the example shown in FIG. 6, the external modules 3a and 3b each have an inductive interface consisting of a transceiver 87 and an antenna 88, shown here explicitly as a coil, via which data can be transmitted between the external modules 3a and 3b.

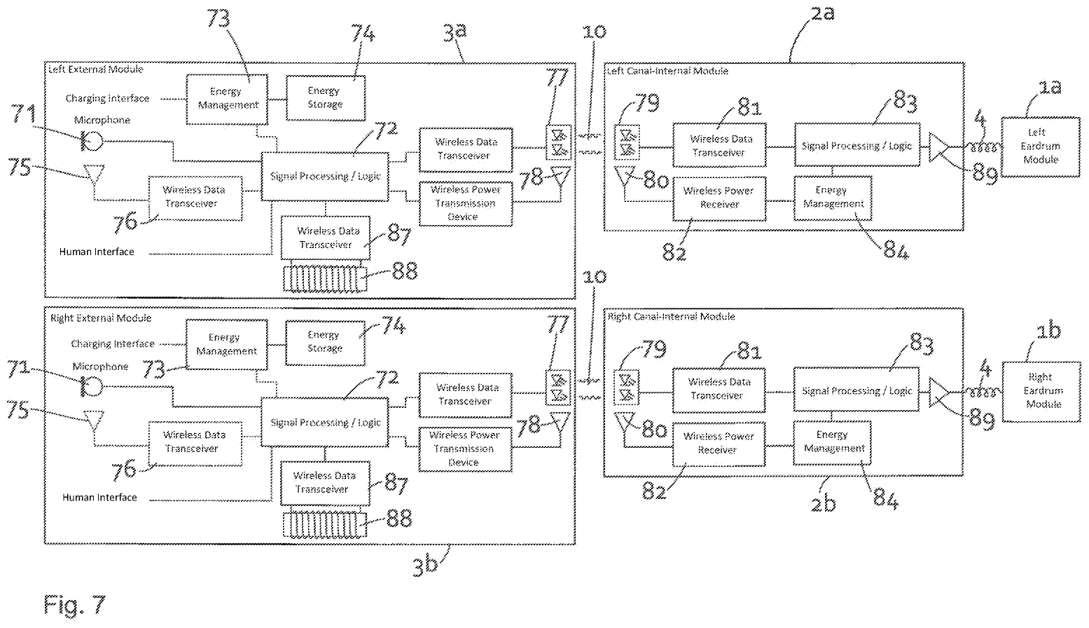

FIG. 7 schematically shows circuitry for another exemplary design of a hearing aid according to the invention. The hearing aid shown in FIG. 7 has one eardrum module 1a and 1b each and one ear canal module 2a and 2b each. The eardrum module 1a, 1b and the ear canal module 2a, 2b are in turn connected to each other by means of a cable 4, via which electrical contact is made. In the example shown in FIG. 7, the hearing aid also has an external unit 3a, 3b, which in this case is designed to be worn permanently in the ear, but which can be removed by the user without professional help to recharge a battery 74 of the external module 3a, 3b. Since the external module in the example shown is worn permanently in the ear and has a battery 74, the ear canal module 2a, 2b does not need to have its own energy storage. This means that the ear canal module 2a, 2b can be made significantly smaller. To transfer energy from the external module 3a, 3b to the ear canal module 2a, 2b, an inductive energy transfer, e.g. by means of inductive transmission, is provided here.

Since the external module 3a, 3b is worn permanently in the ear, it impedes the surge path to the ear canal module 2a, 2b. For this reason, a microphone 71 is provided here in the external module 3a, 3b to pick up sound. An optical connection 10 is provided between the external module 3a, 3b and the ear canal module 2a, 2b for signal transmission. The transmitting and receiving elements 77 and 79 are therefore explicitly shown in this example as a combination of light-emitting diode and photodiode. The audio signal picked up by the microphone of the external module 3a, 3b is transmitted via the optical interface 10 to the ear canal module 2a, 2b and from there via cable 4 to the eardrum module 1a, 1b.

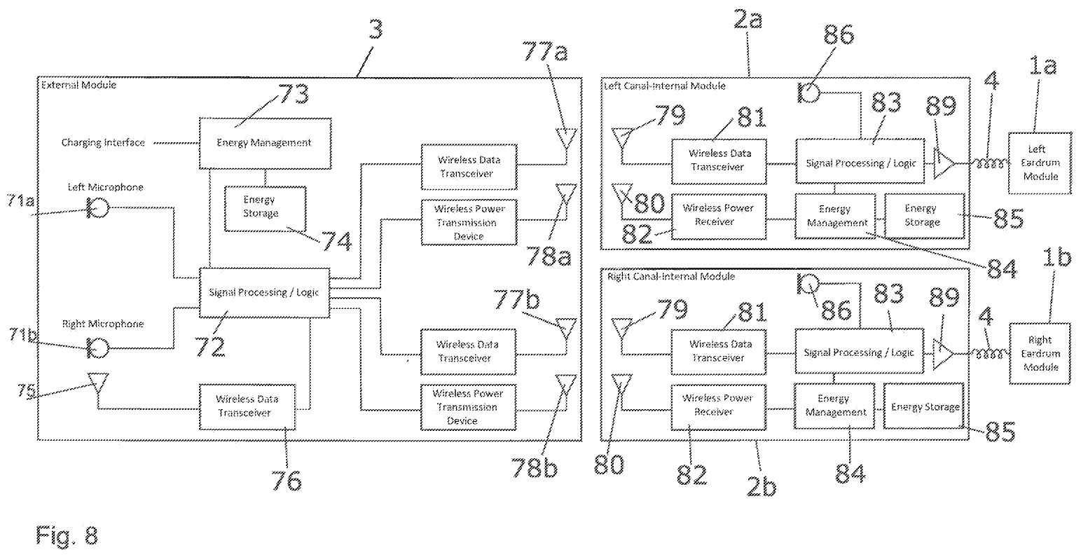

FIG. 8 shows another example of a hearing aid according to the invention with one ear canal module 2a and 2b and one eardrum module 1a and 1b in each ear of the person. The ear canal modules 2a and 2b and the eardrum modules 1a and 1b are constructed as shown in FIG. 6. Reference is made to the description there.

While FIG. 6 shows two external modules 3a and 3b, FIG. 8 shows only one external module 3. This external module 3 contains all the antennas that were distributed between the two external modules 3a and 3b in FIG. 6. Therefore, the external module 3 in FIG. 8 contains two data outputs 77a and 77b and two outputs 78a and 78b, which can be used to transmit data or power to the corresponding inputs 79 and 80 of the ear canal modules 2a and 2b.

In the example shown in FIG. 8, the external unit 3 has a left microphone 71a and a right microphone 71b coupled with a common signal processing unit 72. The external module 3 also has an energy management unit 73, which can be supplied with electrical energy via an external interface and is coupled with an energy storage unit 74. It can also be connected to the signal processing unit 72 for information exchange. The energy management unit 73 also supplies all active units of the external module 3a, 3b with energy via connections (not shown). The signal processing unit 73 is in turn connected to the outputs 77a, 78a, 77b, 78a via data or power transmitters.

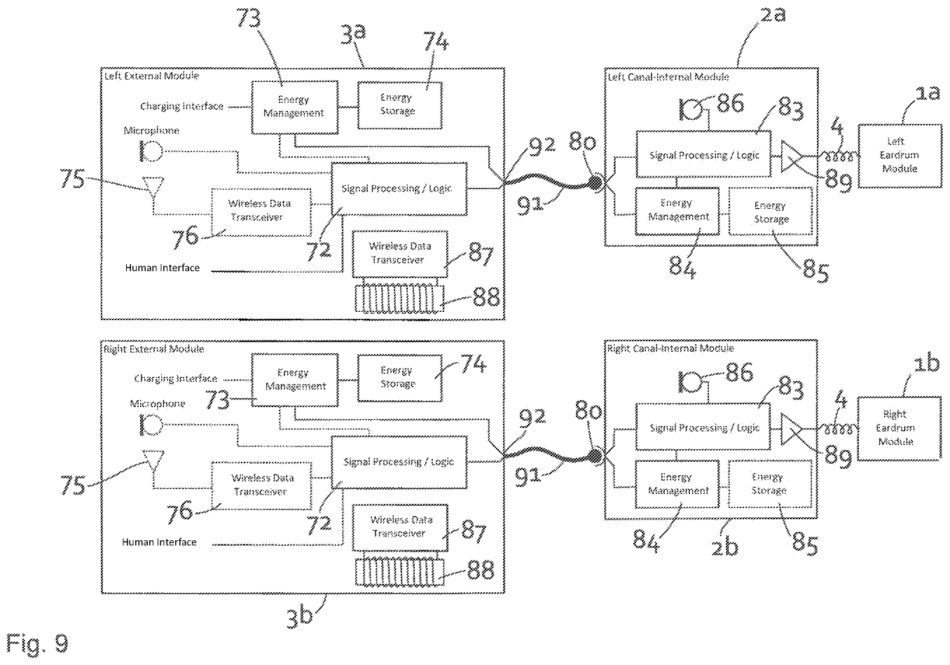

In FIGS. 6 to 8, both energy and data are transmitted from the external modules 3a, 3b and 3, respectively, to the ear canal modules 2a, 2b. Both transmissions are wireless. FIG. 9, on the other hand, shows a design as in FIG. 6, with a separate external module 3a and 3b being provided for each ear. In contrast to FIG. 6, the external modules 3a and 3b are each connected to the corresponding ear canal modules 2a, 2b by a cable 91, via which both power and data signals are transmitted. For this purpose, the external units 3a and 3b each have a common output 92 for energy and data, which is connected to both the energy management unit 73 and the signal processing unit 72 in the corresponding external module 3a or 3b. On the side of the external modules 2a and 2b, cable 91 is connected to the ear canal module 2a and 2b via a detachable plug connection 80. Connector 80 for data and power is connected to a data processing unit 83 and an energy management unit 84. The energy management unit 84 is connected to an energy storage device 85, which can be charged via connector 80 and can supply the active units of the ear canal module with energy.

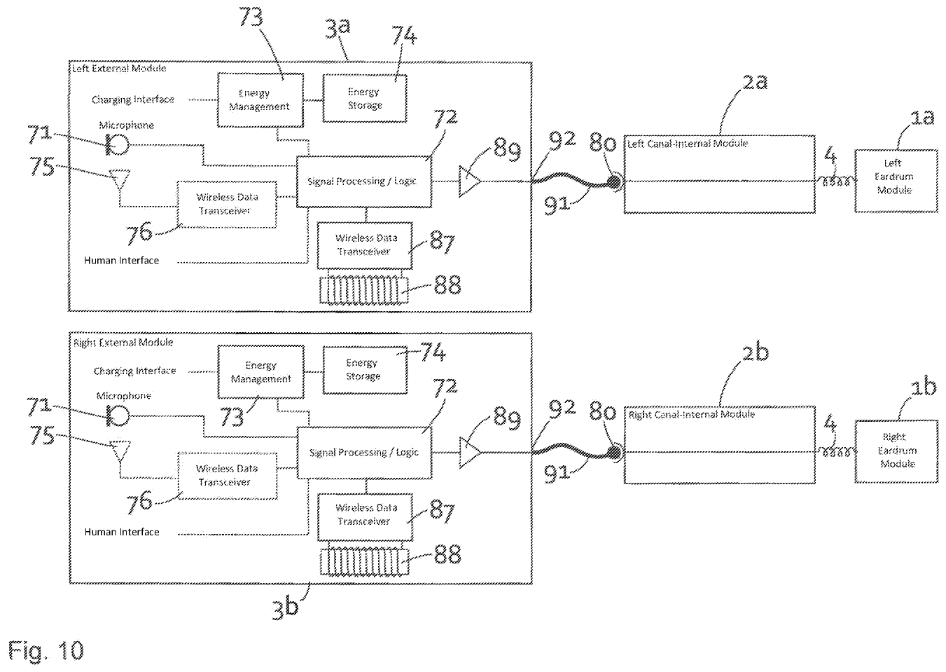

In FIGS. 6 to 9, the ear canal modules 2a and 2b contain active circuit elements that require an auxiliary power supply. FIG. 10 shows an inventive design of the hearing aid in which the ear canal modules 2a and 2b contain only passive electrical components and conduct signals from the external module 3a, 3b to the eardrum module 1a, 1b. As before, the eardrum module 1a, 1b is connected to the ear canal module 2a, 2b via a cable 4. The ear canal module is connected to the external module 3a, 3b via a cable 91 and a detachable plug connector 80. The latter is intended to be worn on the ear, for example in the form of a behind-the-ear device. As in FIG. 7, it can be removed by the user without professional assistance for recharging or replacing a battery 74. The ear canal module establishes a passive electrical connection between connector 80 on the outside and cable 4 to the eardrum module 1a, 1b and serves as a strain relief when removing the external module 3a, 3b.

At the contact point 92 between cable 91 and the external module 3a, 3b, the signal amplified by amplifier 89 disposed in the external module 3a, 3b is introduced for the sound transducer integrated in the eardrum module 1a, 1b.

The external module 3a, 3b has an energy management unit 73 which is connected to an energy storage unit 74. If the energy storage is rechargeable, the external module 3a, 3b has a charging interface which is connected to the energy management unit 73. The external module 3a, 3b also has a signal processing unit 72. This can be connected to the energy management unit 73 for information exchange. It also generates the signal for the transducer, which is routed to amplifier 89. It is furthermore connected to a microphone 71 integrated in the external module 3a, 3b, which picks up audio signals from the surroundings. An inductive data transmission unit 87 with antenna coil 88 is used for data exchange between the two external modules 3a and 3b. Optionally, the external module 3a, 3b can have a radio signal transmitter and receiver unit 76 with an antenna 75 to exchange data with peripheral devices such as a smartphone.

FIG. 11 shows an advantageous design of the invention in which the external module 3 is connected to the eardrum module 2 via a wire 5b. The wire 5b is arranged with its one end on the external module 3 and with its opposite end on an intermediate module 102a, which has a transmitting device for a wired and/or wireless energy and/or signal transmission, for example contact pins, a light source, a coil and/or a capacitor plate.

Ear canal module 2 has a receiving device 102b for wired and/or wireless energy transmission, which, corresponding to the transmitting device in intermediate module 102a, may have, for example, electrical contact surfaces, a device for converting light energy into electrical energy, a coil or a capacitor plate. In the example shown, ear canal module 2 is connected to eardrum module 1 via cable 4. For example, intermediate module 102a and/or ear canal module 2 can be held in ear canal 7 by means of an anchoring device 102c, which is located on an outer side of the respective components and touches the wall of the ear canal.

FIG. 12 shows an optional configuration of the invention in which the ear canal module has a through-hole 100. The cable 4 connected to the eardrum module 1 can be led therethrough to the outside. In a method in accordance with the invention, the eardrum module 1 can then first be arranged on the eardrum 9. Cable 4 can be held outside the ear canal and the ear canal module 2 can be slid onto cable 4 by passing cable 4 through opening 100. The ear canal module 2 can then be inserted into the ear canal and the cable 4 pulled through the opening 100. Cable 4 may have a marking 101 which indicates whether the ear canal module has been advanced sufficiently far along the cable. Cable 4 may have a contact point 102 which can be used to make electrical contact with contacts 103 of the ear canal module. The contact point 102 is located on the cable where the contacts of the ear canal module 103 are located when arranged as intended.

1. A hearing aid, comprising
an eardrum module arranged to be in contact with an eardrum of a person,
an ear canal module configured to be placed in the ear canal of a person,
wherein the eardrum module and the ear canal module are, when they are disposed in an ear of the person, connected to each other only by at least one cable,
wherein the eardrum module and the ear canal module are electrically contacted with each other via the at least one cable.

2. The hearing aid according to claim 1, wherein the cable is extendable.

3. The hearing aid according to claim 1, wherein the cable is at least one of: elastically extendable from a wound or folded state or the cable is made of an elastic material.

4. The hearing aid according to claim 1, wherein the cable is wound into a spiral shape.

5. The hearing aid according to claim 1, wherein the cable comprises a flexible laminate, said flexible laminate comprising at least one electrically insulating layer and at least one electrically conductive layer.

6. The hearing aid according to claim 1, wherein the cable is connected to the ear canal module via at least one of: a plug connection or an abutting connection.

7. The hearing aid according to claim 1, wherein the cable is connected to the eardrum module in at least one of: a nondetachable or integrally bonded manner.

8. The hearing aid according to claim 1, wherein the eardrum module has at least one actuator and is configured such that a vibration of the actuator is transmissible to the eardrum when the eardrum module is in contact with the eardrum.

9. The hearing aid according to claim 8, wherein the actuator has a membrane structure, the membrane structure having at least one carrier layer and at least one piezo layer arranged on the carrier layer and comprising at least one piezoelectric material, so that vibrations of the membrane structure can be generated by applying a voltage to the piezo layer.

10. The hearing aid according to claim 9, wherein the membrane structure is divided into at least two or more segments by at least one intersecting line intersecting all layers of the membrane structure, so that the membrane structure is mechanically decoupled at the intersecting line.

11. The hearing aid according to according to claim 1, wherein the ear canal module has a storage for electrical energy, and wherein the storage is rechargeable.

12. The hearing aid according to claim 1, wherein the ear canal module comprises at least one microphone.

13. The hearing aid according to claim 1, wherein electrical energy is capable of being wirelessly supplied to the ear canal module.

14. The hearing aid according to claim 1, wherein electrical energy is capable of being supplied to the ear canal module via at least one of: a reconnectable detachable, positive, or a nonpositive connection.

15. The hearing aid according to claim 1, further comprising an external module which is configured to be connected to the ear canal module for supplying the ear canal module with at least one of: electrical energy, an information signal, or which is configured to be connected to the ear canal module for supplying the eardrum module with the at least one of: electrical energy or information signal.

16. The hearing aid according to claim 15, wherein the external module comprises a battery, and wherein the battery is rechargeable.

17. The hearing aid according to claim 16, wherein the external module is connectable to the ear canal module via at least one of: a wireless connection, reconnectable detachable, positive, or a nonpositive connection for supplying the ear canal module with electrical energy.

18. The hearing aid according to claim 16, wherein the external module has at least one ear part shaped so that the at least one ear part is capable of being held by the ear of the person.

19. The hearing aid according to claim 18, wherein the external module comprises a bracket on which the at least one ear part is located and which is configured so that it can reach over a head of the person.

20. The hearing aid according to claim 19, wherein the at least one ear part is sized and shaped or otherwise configured to be placed in one ear canal of the person.

21. The hearing aid according to claim 15, wherein the external module has at least one microphone.

22. The hearing aid according to claim 15, wherein a signal transmission connection e is capable of being established between the external module and the ear canal module.

23. The hearing aid according to claim 22, wherein the signal transmission connection is independent of the connection for supplying the ear canal module with electrical energy or wherein the signal transmission connection is made via the connection for supplying the ear canal module with electrical energy.

24. The hearing aid according to claim 15, wherein the external module has an interface for establishing a connection to an external device.

25. The hearing aid according to claim 15, wherein the external module has an interface for at least one of: receiving an operating command or for receiving an audio signal from an audio source.

26. The hearing aid according to claim 15, wherein the external module has at least one operating element with which the hearing aid is operated.

27. The hearing aid according to claim 15, wherein the external module is connected via a cable to an intermediate module that is configured to be placed in the ear canal of the person, wherein the intermediate module comprises a transmitting device for at least one of: a wired power transmission, a wired signal transmission, a wireless power transmission, or a wireless signal transmission, and wherein the ear canal module has a receiving device for at least one of a wired energy transmission, a wired signal transmission, a wireless energy transmission, or a wireless signal transmission.

28. The hearing aid according to claim 1, wherein the ear canal module has at least one throughhole which extends from a side of the ear canal module facing the eardrum to a side of the ear canal module facing outwards.

29. A method for arranging a hearing aid in an ear of a person, the method comprising:
arranging an eardrum module to be in contact with an eardrum of the person, wherein a cable is located outside the ear with an end facing away from the eardrum module;
leading the cable through a throughhole in an ear canal module; and
guiding the ear canal module on the cable into the ear canal of the person.

30. The method according to claim 29, wherein the cable has at least one contact point in electrical contact with the ear canal module when the ear canal module is arranged in the ear canal.

31. The method according to claim 29, wherein the cable has a marking at a position where the ear canal module is located on the cable, the ear canal module being guided on the cable into the ear canal of the person to at least one of: the marking or to a defined distance from the marking.
